(19) United States
(12) Patent Application Publication
(10) Pub. No.: US 2025/0098035 A1
(43) Pub. Date: Mar. 20, 2025

(54) IR EMITTER DEVICE

(71) Applicant: 4K-MEMS SA, St-Blaise (CH)

(72) Inventor: Ross Stanley, Epalinges (CH)

(21) Appl. No.: 18/727,927

(22) PCT Filed: Feb. 7, 2023
(86) PCT No.: PCT/IB2023/051067

§ 371 Date: Jul. 10, 2024

(30) Foreign Application Priority Data
Feb. 8, 2022 (EP) 22155542.8

(51) Int. Cl. H05B 3/26

(52) U.S. Cl. CPC H05B 3/26

(57) ABSTRACT

An IR emitter device includes an IR emitting membrane having a first surface and a second surface, and a mirror facing the first or second surface. The IR emitting membrane is arranged to be heated to an IR emission temperature so that the first and second surfaces radiate IR light at the IR emission temperature. The emissivity of the first and second surfaces is lower than 0.7. At least a portion of the IR emitting membrane includes through holes. Any cross section of said holes in a plane parallel to the first or second surface has a maximum dimension larger than the longest wavelength of the predefined region of the electromagnetic spectrum for which the IR emitter device has been designed. The sum of the areas of the holes is at least 10% of the area of each of the first or second surfaces.

### TECHNICAL DOMAIN

The present invention concerns an infrared (IR in the following) emitter device made from a refractory material. This device is capable of emitting broadband infrared radiation at temperatures of over 2000 K.

### RELATED ART

In this context, the IR light has a wavelength belonging to the range from 0.8 μm to 12 μm.

IR emitters for such diverse applications as for example (but not limited to) infrared spectroscopy, illumination for gas sensing, as hotplates for a chemical platform, or as hotplate inserts in transmission electron microscopes (TEM) or scanning electron microscopes (SEM) are known.

Examples of known IR emitters are described in the patent applications WO2020012042, WO2021144463 or WO2021144464 filed by the applicant.

IR emitters emit light according to the blackbody theory of radiation. This gives detailed information about how the emission intensity varies with temperature and wavelength.

However, no real materials are truly black, so the blackbody emissivity has to be scaled by a parameter called the emissivity, ε, which is a function of wavelength and temperature.

Most IR thermal emitters are based on materials which are as black as possible, i.e., which have an & at the wavelength range of interest close to 1.0. The drawback is that, there are very few materials with high emissivities and in general they can only survive relatively low temperatures, i.e. to temperature below 2000 K.

Most IR thermal emitters are made from a refractory material. A refractory material is a material with a melting point above 2000° C. Examples of refractory materials are Tungsten, Titanium, Hafnium, Zirconium, Tantalum, Molybdenum and their Nitrides, Oxides and Carbides. Refractory metals are metals with a melting point above 2000° C.

At IR wavelength refractory metals are quite reflective (Reflectivity ranging from 30% to more than 99%) and the corresponding emissivity belongs to the range of 0.7 to 0.01. The advantage of refractory metals is that they are stable at high temperature, the disadvantage is their low intrinsic emissivity.

In order to have high efficiency, it is interesting to improve the emissivity of an IR emitter device by surface structuring. It is well-known that a rough structure has a higher emissivity then a smooth surface.

It is known that sub-wavelength structures can greatly enhance the emissivity of metal surfaces. There are two main methods, the first is to structure the surface to couple light into surface waves known as surface plasmons. The surface structure is in general a periodic structure which acts like a diffraction grating to couple light from normal incidence into a surface wave. The most important drawback is that this technique is very sensitive to both wavelength and angle of incidence of the light. When averaged over all angles, such structures only increase the emissivity by a few percent at best.

The second method is to use very small features in the metal to enhance absorption by a mixture of diffraction and scattering. The drawback of such structures is that, the feature size is very small which makes manufacturing difficult. Moreover, the structures are unstable when heated due to the very large surface area. In the range from 0.8 μm to 2 μm for those small features, the emissivity of for example tungsten is between 0.2 and 0.4.

There are mixed methods which combine the two ideas, but in all cases the metal is structured at the submicron level which makes the method sensitive to imperfections created during fabrication or during usage.

Therefore, many known solutions to increase the emissivity are based around either very small structures with respect to the operating region and/or resonant structures which rely on precise dimensions of structure either in their size, their format or their periodicity. On the other hand it is well known that—at high temperatures-materials undergo processes such as electromigration or the Soret effect. These processes cause migration of atoms on the surface of the material and after some time the surface becomes roughened. The smaller the feature size the more likely it will be deformed and its advantage for emissivity enhancement will be lost. This is problematic for their implementation at high temperatures.

To summarize, the state-of-the-art uses either periodic structures which work at a single wavelength and/or sub-wavelength structures which are difficult to fabricate, have a limited lifetime and lose emissivity enhancement at high temperatures, or do not age well at high temperatures.

The document DE102018101974 describes a monolithic radiator element for infrared spectroscopic devices, arranged in a cantilevered manner in a hermetically sealed housing. The IR-radiation-emitting surface comprises a nanostructure with nanorods standing perpendicularly on IR-radiation-emitting surface. The emissivity of the radiator element can be adjusted by the structure size of the nanorods.

Therefore, there is a need of an IR emitter device with improved emissivity and that overcomes the shortcomings and limitations of the state of the art.

### SHORT DISCLOSURE OF THE INVENTION

An aim of the present invention is the provision of an IR emitter device with improved emissivity and that overcomes the shortcomings and limitations of the state of the art.

Another aim of the invention is the provision of an IR emitter device with improved emissivity and easy to fabricate and/or with a lifetime longer than known solutions.

Another aim of the invention is the provision of an IR emitter device that does not lose emissivity enhancement at high temperatures.

Another aim of the invention is the provision of an IR emitter device with improved emissivity and less sensitive to wavelength and/or angle than known solutions.

According to the invention, these aims are attained by the object of the attached claims, and especially by an IR emitter device according to claim 1.

The IR emitter device according to the invention comprises an IR emitting membrane comprising a first surface and a second surface, the second surface being opposite to the first surface, wherein the IR emitting membrane is arranged to be heated to an IR emission temperature so that the first and second surfaces radiate IR light at the IR emission temperature. In one embodiment, the IR emission temperature is higher that 2000 K.

In this context, the term “membrane” designate an element whose thickness is lower than its other two dimensions. In one preferred embodiment, the membrane is substantially planar. In one preferred embodiment, the membrane can support itself, i.e. it is structurally independent. In another embodiment, the membrane cannot support itself, unless attached on all sides.

According to the invention, the emissivity of the first and second surfaces is lower than 0.7. In fact, the invention aims to improve the emissivity of an IR emitter device, and this improving is useful for low-emissivity materials, i.e. for materials having an emissivity lower than 0.7. In other words, there is not so much interest for enhancing the emissivity of good emitter materials, i.e. of materials having an emissivity equal or higher than 0.7.

According to the invention, the device comprises also a mirror facing one of the first or second surfaces of the IR emitting membrane.

According to the invention, at least a portion of the IR emitting membrane comprises through holes (apertures), wherein any cross section in a plan parallel to one of the first or second surfaces of the IR emitting membrane of said through-holes has a maximum dimension larger than the longest wavelength of the predefined region of the electromagnetic spectrum for which the IR emitter device is designed to work. This condition allows the radiated IR light to pass in a free way through the holes, without reflection on the aperture of the hole belonging to the (external) surface of the membrane. In other words, the cut-off wavelength for light propagating in the hole is longer than the maximum wavelength used in the device application. In other words again, this condition allows to IR emitter device to act as a sieve or a colander for the IR emitted light, that freely pass through the holes of the IR emitter device.

The IR emitter device according to the invention is designed for a predefined region of the electromagnetic spectrum, i.e. it is designed to work in a predefined region of the electromagnetic spectrum.

In one embodiment, this predefined region of the electromagnetic spectrum is the short wave infrared region (SWIR), ranging from 0.9 μm to 3 μm. In this region, the IR emitter device according to the invention can be used as a thermal emitter for spectroscopic applications or material analysis. Such spectroscopy is useful for identify materials such as plastics, organic solids and liquids, skin and properties of plant to mention some examples, and are used by industries such as recycling, health care, pharmaceuticals or agriculture. In this embodiment, any cross section in a plan parallel to one of the first or second surfaces of the IR emitting membrane of the through-holes of the IR emitter device according to the invention has a maximum dimension larger than 3 μm.

In one embodiment, this predefined region of the electromagnetic spectrum is the mid-infrared region (MIR), ranging from 3 μm to 5 μm. In this region, the IR emitter device according to the invention can be used as a non-dispersive gas sensor to detect non-dispersive gases, such as carbon dioxide. The IR emitter device according to the invention used as a non-dispersive gas sensor can be followed by a spectral filter. In this embodiment, any cross section in a plan parallel to one of the first or second surfaces of the IR emitting membrane of the through-holes of the IR emitter device according to the invention has a maximum dimension larger than 5 μm.

In one embodiment, this predefined region of the electromagnetic spectrum is the long wave infrared or thermal infrared region (LIR), ranging from 8 μm to 12 μm. In this region, the IR emitter device according to the invention can be used for dispersive gas sensing or glucose detection or thermal imaging, among others. In this embodiment, any cross section in a plan parallel to one of the first or second surfaces of the IR emitting membrane of the through-holes of the IR emitter device according to the invention has a maximum dimension larger than 12 μm.

For the different regions, the operating temperature (or the IR emission temperature) is selected to have the maximum spectral overlap with the predefined region of interest, e.g. according to the Stefan's displacement law. In other words, an IR emitter device arranged to work in a predefined region of interest is an IR emitter device arranged to be heated at an IR emission temperature allowing it to radiate IR light having the maximum spectral overlap with the predefined region of interest, or having the peak emission in this predefined region of interest, for example in the middle of this predefined region.

For example, for having a peak emission at 1.05 μm or 1.5 μm (SWIR applications), the IR emission temperature should be around 2000 K. For having a peak emission at 4 μm (MIR applications), the IR emission temperature should be around 700 K. For having a peak emission at 10 μm (LIR applications) the IR emission temperature should be around 300 K. However these are in general minimum operating temperatures. In practice, higher temperatures always create more light at the wavelength of interest: as a consequence, thermal emitters for LIR for example have working temperatures closer to 1000 K. In general this gives a push to have high temperature emitters. The drawback of most materials that survive high temperatures is their low emissivity, hence the interest to improve the emissivity by the means of the device according to the invention.

According to the invention, the sum of the areas of the holes is at least 10% of the area of each of the first or second surfaces of the IR emitting membrane. In other words, the IR emitting membrane should sufficiently perforated.

The current invention looks at using a membrane with through holes and a mirror, to enhance the emissivity of an IR emitter device made by a material having an emissivity lower than 0.7.

Thanks to the presence of the mirror, the wavelength of the radiated IR light reflects at least once before exit via the holes, and this reflection allows to raise the emissivity of the device. In other words, the invention allows to reflect some of the light emitted from the IR emitting membrane back off the same surface, and this allows to increase the effective emissivity.

The IR emitter device of the invention is simple to manufacture. Moreover, it is less sensitive to wavelength and/or angle than known solutions.

The holes do not have to be uniform in size nor periodic which is an advantage for manufacture and wavelength sensitivity.

There is another important advantage related to the invention: since holes are present, there is less mass to heat up and this renders the IR emitter device of the invention more efficient than known solutions.

The IR emitter device according to the invention does not exploit at all any interference between the (directly) emitted light and the emitted light which is reflected by the mirror. This renders the IR emitter device according to the invention independent on the wavelength of the emitted light and on the distance between the membrane and the mirror.

Finally, the IR emitter device according to the invention does not lose emissivity enhancement at high temperatures, since the sieve or a colander effect provided by the through holes is not affected by high temperatures.

In one embodiment, the IR emitting membrane is made by (or comprises) a refractory material, e.g. a refractory metal and/or an alloy of refractory metals.

In one embodiment, the surface of the mirror facing the IR emitting membrane is an IR emitting surface. In this case, the mirror can be referred to as a “hot mirror”.

In one embodiment, the surface of the hot mirror facing the IR emitting membrane, the first surface and the second surface of the IR emitting membrane are made by the same material.

In one embodiment, the IR emitting device is a monobloc device.

In one embodiment, the surface of the mirror facing the IR emitting membrane is not an IR emitting surface, wherein the reflectivity of the mirror is higher than 80% (i.e. it is a mirror highly reflecting). In this case, the mirror can be referred to as a “cold mirror”.

In one embodiment, the thickness of the IR emitting membrane is higher than 0.1 times the mean distance between the holes. In this case, the membrane can be referred to as a “thick membrane”. This embodiment allows a further improvement of the emissivity, as it exploits the reflections on the internal walls of the holes.

In one embodiment, the ratio of the area of the hole and the area of the sidewalls of the hole is lower than 1. This embodiment allows a further improvement of the emissivity, as it exploits one more the reflections on the internal (side) walls of the holes.

In this context, the expression “area of the hole” designate the area of the hole on an external surface of the emitting membrane comprising the hole, i.e. on the first surface or on the second surface. In one embodiment, the area of the hole on the first surface is equal to the area of the hole in the second surface (in other words, the hole is substantially cylindrical).

In one embodiment, the thickness of the IR emitting membrane is equal or lower than 0.1 times the mean distance between the holes, wherein the sum of the areas of the holes is less than 50% of the area of each of the first or second surfaces of the IR emitting membrane. In this case, the membrane can be referred to as a “thin membrane”.

In one embodiment, the mirror is planar, and the distance of the mirror from the membrane is a multiple of the average distance between two adjacent holes or a multiple of the holes period.

In one embodiment, at least some of the holes are squared holes.

In one embodiment, at least some of the holes are cross holes.

In one embodiment, the IR emitting membrane is a single piece membrane.

In one embodiment, the IR emitting membrane is a multi-layer membrane.

In one embodiment, the arrangement of the holes is not periodic (e.g. a random arrangement) and/or the holes have different sizes and/or different shapes. In fact, the IR emitter device according to the invention does not exploit at all “coherent” effects due to diffraction and surface plasmon effects, which requires a periodic arrangement of the sub-wavelength structures and/or sub-wavelength structures having equal size and/or equal shape.

In one embodiment, the (membrane of the) IR emitter device comprises a plurality of resistive arms connected to the IR emitting membrane, wherein the IR emitting membrane is suspended by the resistive arms, wherein the IR emitting membrane is heated to an IR emission temperature via those resistive arms. In one embodiment, the IR emitter device comprises also features as described in the documents WO2020012042, WO2021144463 or WO2021144464 filed by the applicant and enclosed here by reference.

In one embodiment, the IR emitter device according to the invention is used for an InGaAs detector. In this embodiment, any cross section in a plan parallel to one of the first or second surfaces of the IR emitting membrane of said through-holes has a maximum dimension larger than 1.6 μm.

In one embodiment, the IR emitter device according to the invention is used for CO₂ sensing. In this embodiment, any cross section in a plan parallel to one of the first or second surfaces of the IR emitting membrane of said through-holes has a maximum dimension larger than 4.2 μm.

In one embodiment, the IR emitter device according to the invention is heated to an IR emission temperature of 4000 K. In this embodiment, any cross section in a plan parallel to one of the first or second surfaces of the IR emitting membrane of said through-holes has a maximum dimension larger than 1 μm.

In one embodiment, the distance between the (first or second) surface of the IR emitting membrane facing the mirror and the mirror is zero. In other words, the first or second surface of the IR emitting membrane facing the mirror and a surface of the mirror are in direct contact. In other words again, since a surface of the mirror is in direct contact with one of the first or second surfaces of the IR emitting membrane, the holes of whole (emphasis) IR emitter device are blocked holes, since they are blocked by the mirror.

In this embodiment, the mirror can be a “hot mirror”. In this embodiment, the holes can be relatively deep, e.g. the membrane is a “thick membrane”, so as to exploit the reflections on the internal walls of the holes. In this embodiment, the ratio of the area of at least one hole and the area of the sidewalls of this hole can be lower than 1, so as to exploit one more the reflections on the internal (side) walls of the holes.

### SHORT DESCRIPTION OF THE DRAWINGS

Exemplar embodiments of the invention are disclosed in the description and illustrated by the drawings in which:

FIG. 1 illustrates schematically an IR emitter system for explaining the Lagrange invariant.

FIG. 2 illustrates a cut section of a portion of an IR emitter device according to one embodiment of the invention.

FIG. 3 illustrates a cut section of a portion of an IR emitter device according to another embodiment of the invention.

FIG. 4 illustrates a cut section of an embodiment of a portion of an IR emitting membrane of an IR emitter device according to the invention.

FIG. 5A illustrates a cut section of an embodiment of a portion of a (thick) IR emitting membrane of an IR emitter device according to the invention.

FIG. 5B illustrates a cut section of a portion of an IR emitter device according to one embodiment of the invention, comprising a (thick) IR emitting membrane comprising a surface having a distance from the mirror equal to zero.

FIGS. 6A to 6E illustrate top view of possible embodiments of the holes the IR emitting membrane of the emitter device according to the invention.

FIG. 7 shows the emissivity enhancement ratio as a function of the fill factor and of the material emissivity of the membrane, for a thin membrane and a cold mirror having a reflectivity of 95%.

FIG. 8 shows the emissivity as a function of the fill factor and of the material emissivity of the membrane, for a thin membrane and a cold mirror having a reflectivity of 95%.

FIG. 9 shows the emissivity enhancement ratio as a function of the fill factor and of the membrane thickness (normalized to the hole period), for a thick membrane and a cold mirror having a reflectivity of 100%, for an IR emitting membrane having emissivity equal to 0.4.

FIG. 10 shows the emissivity enhancement ratio as a function of the fill factor and of the membrane thickness (normalized to the hole period), for a thick membrane and a cold mirror having a reflectivity of 100%, for an IR emitting membrane having emissivity equal to 0.1.

FIG. 11 shows the emissivity enhancement ratio as a function of the fill factor and of the membrane thickness (normalized to the hole period), for a thick membrane without a cold mirror, for an IR emitting membrane having emissivity equal to 0.4.

FIG. 12 shows the emissivity enhancement ratio as a function of the fill factor and of the membrane thickness (normalized to the hole period), for a thick membrane without a cold mirror, for an IR emitting membrane having emissivity equal to 0.1.

FIG. 13 shows the emissivity enhancement ratio as a function of the ratio square size/period and of the membrane thickness (normalized to the hole period), for a thick membrane with a hot mirror, for an IR emitting membrane having emissivity equal to 0.1 and comprising square holes.

FIG. 14 shows an example of an IR emitter device according to the invention, wherein the IR emitting membrane comprises a plurality of resistive arms connected to the IR emitting membrane.

### EXAMPLES OF EMBODIMENTS OF THE PRESENT INVENTION

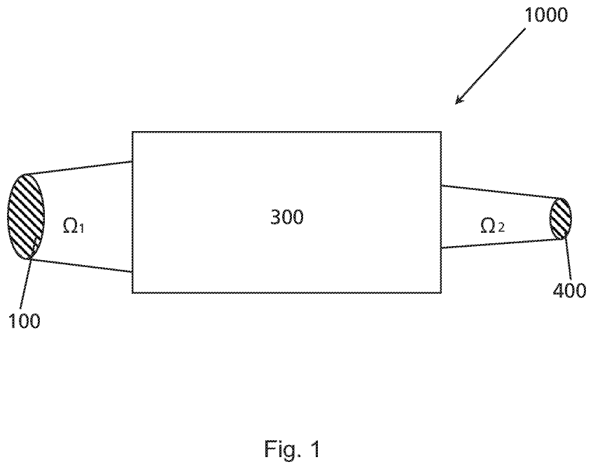

FIG. 1 illustrates schematically an IR emitter system 1000 for explaining the Lagrange invariant. It comprises a first IR emitter device 100, (any) optics 300 and a second IR emitter device 400. According to this invariant, etendue is always conserved. The simplest formulation of this invariant, is that the product of the area of an IR emitter device with the corresponding solid angle is conserved. In other words, if the area of the first IR emitter device 100 is dA₁ and its corresponding solid angle 221 and if the area of the second IR emitter device 400 is dA₂ and its corresponding solid angle Ω₂, then

$$d {A}_{1} \cdot {Ω}_{1} = d {A}_{2} \cdot {Ω}_{2} \qquad ( 1 )$$

Let the emissivity of the area dA₁ being ε. Since ε by definition is less than one, then there is nothing one can do to increase the emissivity with external optics. This is why so much effort is spent to improve the material emissivity.

According to the invention, the emissivity is improved by using a special IR emitter device, i.e. an IR emitter device comprising a membrane with holes and a mirror, according to claim 1.

For an absorbing material ε=1−Rₘ, where Rₘ is the reflectivity of the material. By reflecting some of the light emitted from the material back off the same surface, then it is possible to increase the effective emissivity.

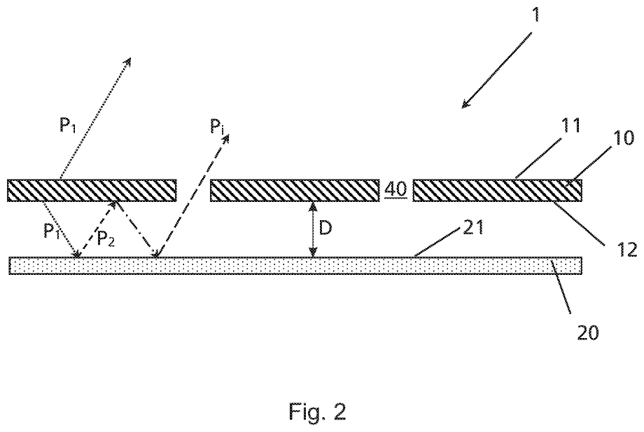

FIG. 2 illustrates a cut section of a portion of an IR emitter device 1 according to one embodiment of the invention. In this embodiment, the IR emitter device 1 comprises an IR emitting membrane 10 comprising a first surface 11 and a second surface 12, the second surface 12 being opposite to the first surface 11, wherein the IR emitting membrane 1 is arranged to be heated to an IR emission temperature so that the first and second surfaces 11, 12 radiate IR light at the IR emission temperature. The size and the proportion of the different elements illustrated in FIG. 2 are just indicative and do not necessarily correspond to the real size respectively proportion. The same applies to the inclination of the depicted arrows.

According to the invention, the emissivity ε of the first and second surfaces 11, 12 is lower than 0.7. In one embodiment, the first and second surfaces 11, 12 are made by the same material. In another embodiment, the first and second surfaces 11, 12 are made by different materials, but having both an emissivity lower than 0.7. Non limitative examples of material having an emissivity lower than 0.7 in the IR comprises a refractory material, e.g. a refractory metals and their alloys. Examples of refractory metals are Tungsten, Titanium, Hafnium, Zirconium, Tantalum, Molybdenum and their Nitrides, Oxides and Carbides.

Although the first and second surfaces 11, 12 have been represented as parallel, this is not essential for the invention. Although the first and second surfaces 11, 12 have been represented as substantially plate, again this is not essential for the invention.

In the illustrated embodiment, the IR emitting membrane 10 is a single piece membrane. In another embodiment, illustrated in FIG. 4, the IR emitting membrane 10 is a multi-layer membrane, i.e. it comprises at least one layer 13 (of a different material) between the first and second surfaces 11, 12.

According to the invention, at least a portion of the IR emitting membrane 10 comprises through holes 40, wherein any cross section in a plan parallel to one of the first or second surfaces of the IR emitting membrane of said through-holes has a maximum dimension larger than the longest wavelength of the emitted infrared radiation in the predefined region of the electromagnetic spectrum. This last condition allows the radiated IR light to pass in a free way through the holes 40, without reflection on the aperture of the hole belonging to the (external) surface of the membrane. In one preferred embodiment, the IR emitter device is designed so that it works only up to a certain maximum wavelength which is decided by the application. In one preferred embodiment, the IR emitter device is designed so that the emitted infrared radiation belongs to the range 0.9 μm to 3 μm, to the range 3 μm to 5 μm or to the range 8 μm to 12 μm.

According to the invention, the sum of the areas of the holes 40 is at least 10% of the area of each of the first or second surfaces 11, 12 of the IR emitting membrane 10. In other words, the “fill factor” of the IR emitting membrane 10 is at least 10%. In fact, the invention allows to sufficiently raise the emissivity of the IR emitter device, if the IR emitting membrane 10 is sufficiently perforated.

The shape and the arrangement of the holes 40 is not important for the working of the invention, as long as the “fill factor” of the IR emitting membrane 10 is at least 10%. This implies that the holes 40 are not necessarily periodic on the IR emitting membrane 10 and that they can have any shape. They can have also different sizes, as long as the wherein any cross section of said through-holes 40 in a plan parallel to one of the first or second surfaces of the IR emitting membrane has a maximum dimension larger than the longest wavelength of the emitted infrared radiation.

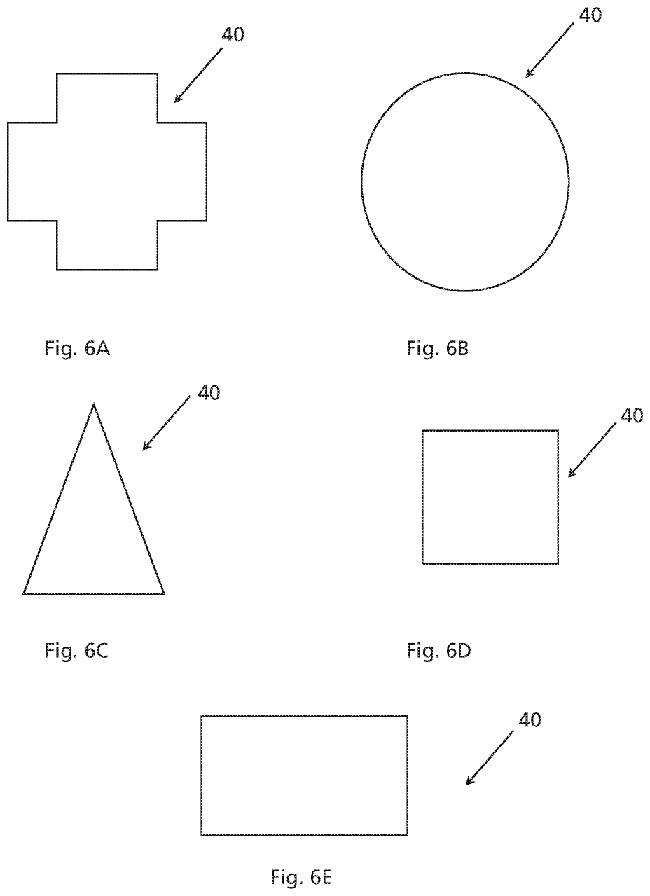

FIGS. 6A to 6E illustrate top view of possible embodiments of the holes 40 the IR emitting membrane 10 according to the invention.

In one embodiment, at least some of the holes 40 are cross holes. A cross structure has about 40% more (side) walls than a similar disc for the same total surface area. A cross like structure allows also wavelengths longer than the width of the arms of the cross to enter (and for both polarizations) as long as the perimeter length is at least twice the wavelength.

According to the invention, the IR emitter device 1 of FIG. 2 comprises also a mirror 20. In the illustrated embodiment, the mirror 20 faces the second surface 12 of the IR emitting membrane 10. In one embodiment, as illustrated in FIG. 2, there is a distance D different from zero between the surface 21 of the mirror 20 facing a surface of the IR emitting membrane (the second surface 12 in FIG. 2 for example) and that surface of the IR emitting membrane 10. In another embodiment, this distance D is equal to zero. In the embodiment illustrated in FIG. 2, the mirror 20 is a cold mirror, i.e. the surface 21 of the mirror 20 facing the IR emitting membrane 20 is not an IR emitting surface. In this specific case, the reflectivity of the mirror 20 is higher than 80%, so as to have sufficient reflections.

In the illustrated embodiment, the mirror 20 is planar. In this case the distance of the mirror 20 from the membrane 10 should be a multiple of the average distance between two adjacent holes 40, or a multiple of the holes period, if present.

However, the mirror 20 should not be necessarily planar and it could have other shapes, for example it could be curved.

The power P₁ is emitted by the IR emitting membrane 10 (also) towards the cold mirror 20. This power is reflected back by the cold mirror 20 as P₂. The number of reflections could be arbitrary, before the IR reflected light founds a hole 40 and exits thought the hole 40 from the space between the mirror 20 and the IR emitting membrane 10, as power Pᵢ. The number of reflections illustrated in FIG. 2 is an example and should not be considered as limitative.

Thanks to the presence of the mirror 20, the wavelength of the radiated IR light reflects at least once before exit via the holes 40, and this reflection allows to raise the emissivity of the device 1. In other words, the invention allows to reflect some of the light emitted from the IR emitting membrane back off the same surface, and this allows to increase the effective emissivity.

Moreover, since holes 40 are present, there is less mass to heat up and this renders the IR emitter device 1 of the invention more efficient than known solutions.

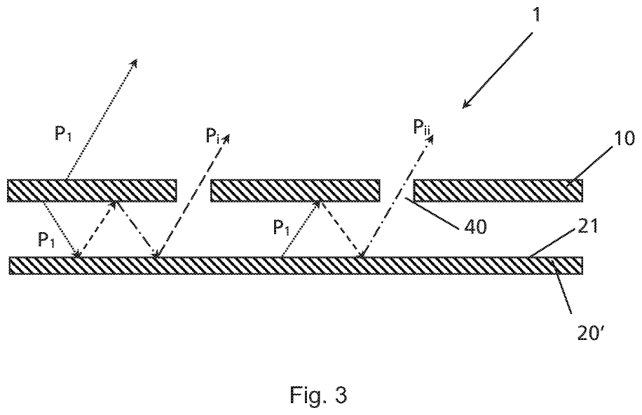

FIG. 3 illustrates a cut section of a portion of an IR emitter device 1 according to another embodiment of the invention. The difference with FIG. 2 is that, the mirror of FIG. 3 is a hot mirror 20′. In one preferred embodiment, it is made (at least partially) by the same material of the material of one of the first or second surfaces 11, 12.

In one embodiment, it is assumed that the hot mirror 20′ has a temperature similar to the IR emitting membrane 10.

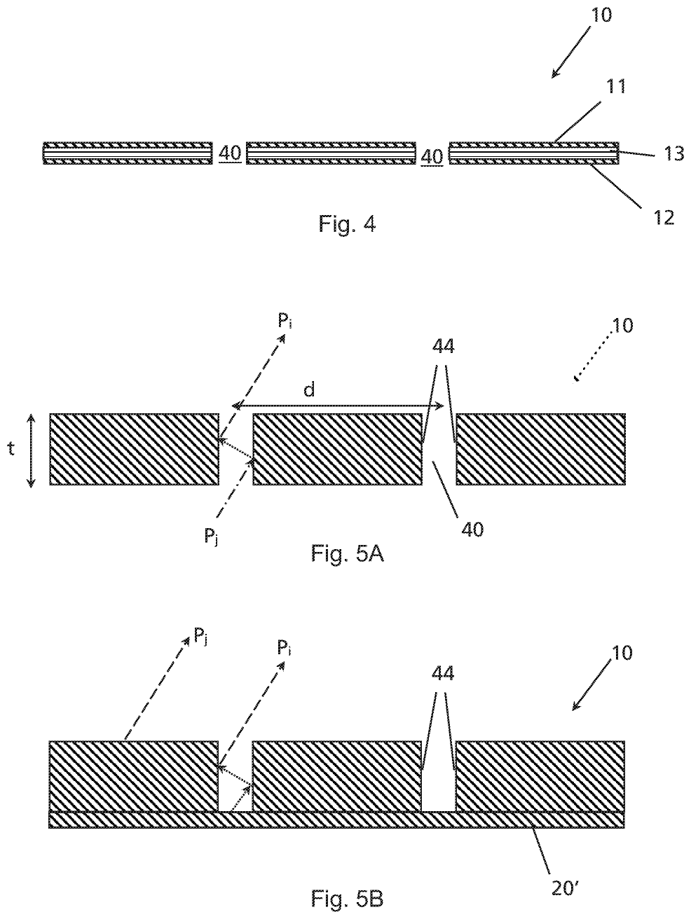

Since the hot mirror 20′ emits as well, the emissivity of the IR emitter device 1 is further improved. In other words, a hot mirror 20′ gives a better device emissivity than a cold mirror 20. Although in the illustrated embodiment, the distance D between the surface 21 of the mirror 20 facing a surface of the IR emitting membrane (the second surface in FIG. 3 for example) and that surface of the IR emitting membrane 10 is different from zero, in another embodiment, this distance D could be equal to zero, as for example illustrated in FIG. 5B.

In one embodiment, the surface 21 of the mirror 20′ facing the IR emitting membrane 10, the first surface and the second surface 11, 12 of the IR emitting membrane 10 are made by the same material. In this embodiment, the IR emitting device could be a monobloc device.

In one embodiment, the thickness t of the IR emitting membrane is higher than 0.1 times the mean distance d between the holes 40, as e.g. illustrated in FIG. 5A. In this case, the IR emitting membrane 10 is considered to be “thick”.

In the case of a thick IR emitting membrane 10, the light is also emitted by the walls 44 of holes in the membrane 10. Moreover, the light can be multiply reflected from the (side) walls 44, as schematically illustrated in FIG. 5A. This improves again the device emissivity, compared to “thin” membranes, i.e. compared to membranes having a thickness equal or lower than 0.1 times the mean distance between the holes 40.

In one preferred embodiment, the ratio of the area of the hole and the area of the walls 44 of the hole 40 is lower than 1.

In one embodiment, which could be combined with the other embodiments of the invention, the distance D between the (first or second) surface of the IR emitting membrane facing the mirror 20, 20′ and the mirror is zero, as for example illustrated in FIG. 5B. In other words, in this embodiment the first or second surface of the IR emitting membrane facing the mirror and a surface of the mirror are in direct contact. In other words again, since a surface of the mirror is in direct contact with one of the first or second surfaces of the IR emitting membrane, the holes 40 of whole IR emitter device are blocked holes, since they are blocked by the mirror.

In this embodiment, the mirror can be a “hot mirror”, as illustrated in FIG. 5B. In this embodiment, the holes can be relatively deep, e.g. the membrane is a “thick membrane”, so as to exploit the reflections on the internal walls 44 of the holes. In this embodiment, the ratio of the area of at least one hole and the area of the sidewalls of the hole can be lower than 1, so as to exploit one more the reflections on the internal (side) walls of the holes. Although this embodiment with D=0 is more efficient with a “thick membrane” and a hot mirror, it could also be used with a “thin membrane” and/or with a cold mirror.

In the embodiments with D=0, the IR emitter device could be a monobloc device.

In the case of a thin membrane 10, the applicant discovered that the sum of the areas of the holes should be less than 50% of the area of each of the first or second surfaces of the IR emitting membrane, in order to improve the emissivity of the device 1. Preferably, the sum of the areas of the holes should belong to the range 5%-25%, and in particular to the range 10%-20%.

In one embodiment, the IR emitter device comprises a plurality of resistive arms connected to the IR emitting membrane, wherein the IR emitting membrane is suspended by the resistive arms, wherein the IR emitting membrane is heated to an IR emission temperature via those resistive arms. In one embodiment, the IR emitter device comprises also features as described in the documents WO2020012042, WO2021144463 or WO2021144464 filed by the applicant.

Here below, a detailed mathematical analysis of some embodiments of the present invention.

### First Embodiment: Thin Membrane and Cold Mirror

In the following, any effects of the thickness of the membrane are ignored, i.e. the side walls of the holes are neglected. Periodic boundary conditions have been used to include the effect of having an (semi-infinite) array of holes. The array of holes can have any arrangement as long as the mean distance between holes is maximized. The holes can have any shape. The only important parameter is the ratio of the area of the holes to the usable device area, i.e. the fill factor F of the holes, which ranges from 0 to 1.

Let e₀ being the emissivity of the emitter and R the reflectivity of the cold mirror. The applicant has found that the emitted power is then:

$${P}_{out} = {e}_{0} ( 1 - F ) [ 1 + \frac{RF}{RF + ( 1 - R ) + R ( 1 - F ) {e}_{0}} ] \qquad ( 2 )$$

The applicant has found that the enhancement due to holes and back mirror is:

$${E}_{enhanced} = \frac{{P}_{out}}{{e}_{0}} = ( 1 - F ) [ 1 + \frac{RF}{RF + ( 1 - R ) + R ( 1 - F ) {e}_{0}} ] \qquad ( 3 )$$

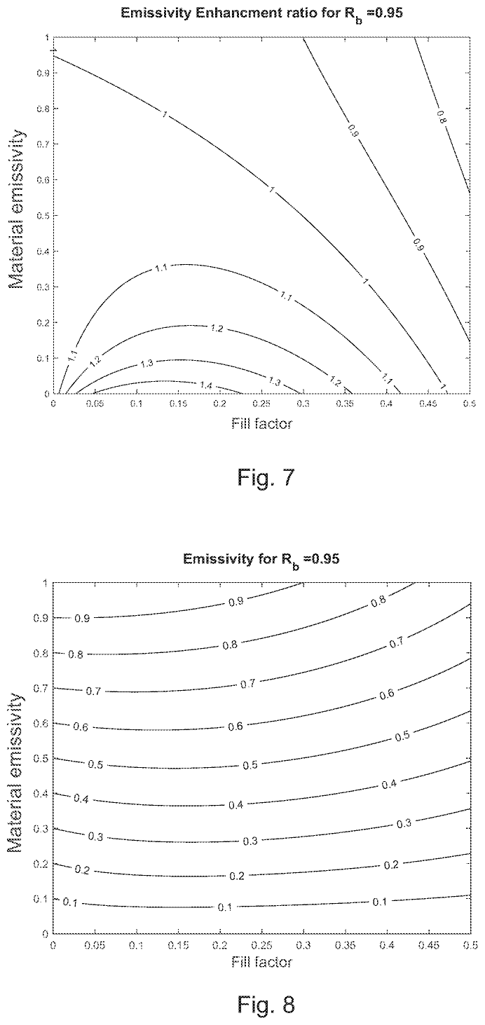

FIG. 7 shows the emissivity enhancement ratio as a function of the fill factor and of the material emissivity of the membrane, for a thin membrane and a cold mirror having a reflectivity of 95%.

FIG. 8 shows the emissivity as a function of the fill factor and of the material emissivity of the membrane, for a thin membrane and a cold mirror having a reflectivity of 95%.

From FIGS. 7 and 8 it is possible to see that a membrane with holes and a back reflector can have a higher emissivity than just a membrane alone and without holes.

### Second Embodiment: Thick Membrane and Cold Mirror

In this embodiment, the effect that light is emitted by the (side) walls of holes in the membrane that light can be multiply reflected from the walls have been considered.

In this embodiment, the holes have been considered as cylindrical, having a radius r and a height h.

Light in a hole escapes by getting out the end faces or absorbed in the walls. The applicant has found that the effective transmission in a given direction is equal to

$${T}_{h} = [ \frac{π {r}^{2}}{π {r}^{2} + π {rhe}_{0}} ] = \frac{r}{r + {he}_{0}} \qquad ( 4 )$$

The hole emits as well. The applicant has found that the hole emits to front as

$${E}_{h} = {e}_{0} {T}_{h} {A}_{h} \qquad ( 5 )$$

$$where$$

$${A}_{h} = \frac{π rh}{{p}^{2}} \qquad ( 6 )$$

is the wall are of the hole, normalized to the holes' period P. This emission is added to both sides.

Escape to outside is reduced due to thick hole, according to the following formulas found bv the applicant:

$${P}_{out} = ( {e}_{0} ( 1 - F ) + {E}_{h} ) [ 1 + \frac{{T}_{h} RF}{RF + ( 1 - R ) + R ( 1 - F ) {e}_{0}} ] \qquad ( 7 )$$

$${E}_{h} = {e}_{0} {T}_{h} {A}_{h} = F ( 1 - {T}_{h} ) \qquad ( 8 )$$

$${P}_{out} = ( {e}_{0} ( 1 - F ) + F ( 1 - {T}_{h} ) ) [ 1 + \frac{{T}_{h} RF}{RF + ( 1 - R ) + R ( 1 - F ) {e}_{0}} ] \qquad ( 9 )$$

In general

$${T}_{h} = \frac{2 {A}^{2}}{2 {A}^{2} + W} \qquad ( 10 )$$

where the area of the hole is A² and the surface area of the walls is W.

We can rewrite this as:

$$T = \frac{1}{1 + \frac{W}{2 {A}^{2}}} \qquad ( 11 )$$

The enhancement factor due to hole shape is:

$${f}_{shape} = W / 2 {A}^{2} \qquad ( 12 )$$

For round holes, this gives an enhancement factor of 1.7726 and for squared holes of 2.

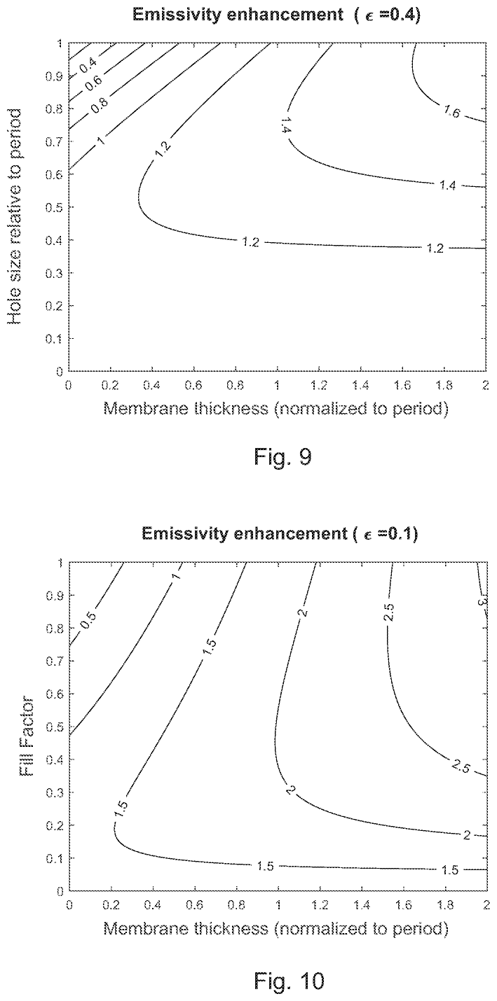

FIG. 9 shows the emissivity enhancement ratio as a function of the fill factor and of the membrane thickness (normalized to the hole period), for a thick membrane and a cold mirror having a reflectivity of 100%, for an IR emitting membrane having emissivity equal to 0.4.

FIG. 10 shows the emissivity enhancement ratio as a function of the fill factor and of the membrane thickness (normalized to the hole period), for a thick membrane and a cold mirror having a reflectivity of 100%, for an IR emitting membrane having emissivity equal to 0.1.

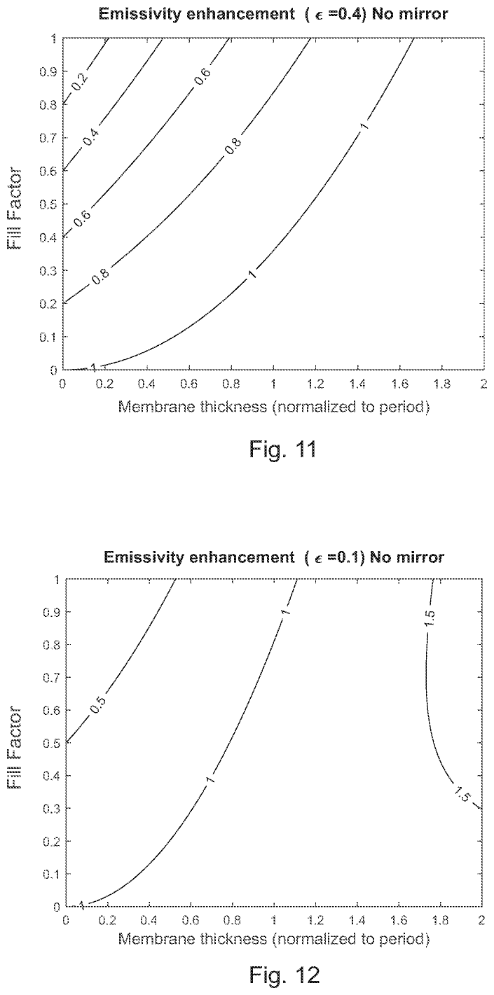

FIG. 11 shows the emissivity enhancement ratio as a function of the fill factor and of the membrane thickness (normalized to the hole period), for a thick membrane without a cold mirror, for an IR emitting membrane having emissivity equal to 0.4.

FIG. 12 shows the emissivity enhancement ratio as a function of the fill factor and of the membrane thickness (normalized to the hole period), for a thick membrane without a cold mirror, for an IR emitting membrane having emissivity equal to 0.1.

From FIGS. 9 to 10, it is possible to find an optimum hole size to thickness ratio.

By resuming, thick membranes are significantly better than thin membranes. The back mirror adds significantly to the enhancement for membrane thicknesses up to twice the period (or mean hole separation). There are clear design rules to maximize the device emissivity for a given material emissivity.

### Third Embodiment: Thick Membrane and Hot Mirror

There is now light emitted from the back mirror. The formula are the same of the second embodiment, except that there is also an emissive term from the back mirror in addition to the reflection term.

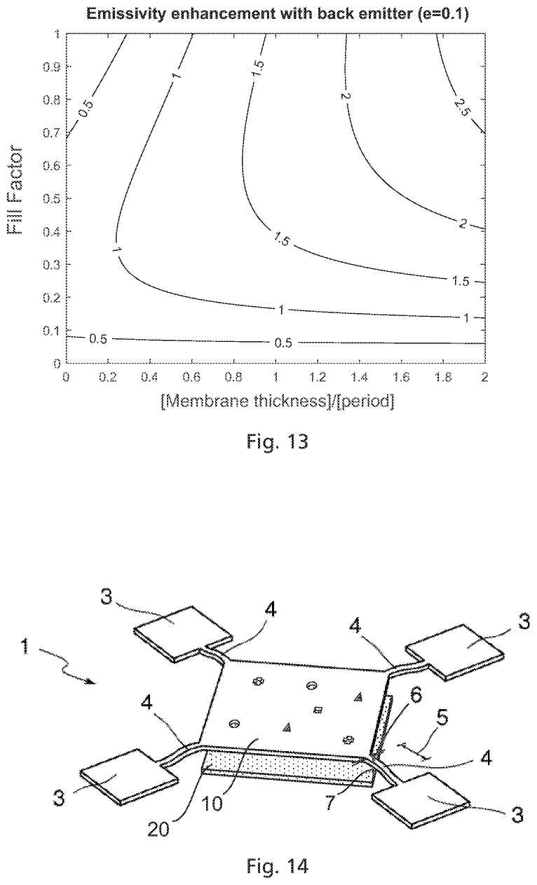

FIG. 13 shows the emissivity enhancement ratio as a function of the ratio square size/period and of the membrane thickness (normalized to the hole period), for a thick membrane with a hot mirror, for an IR emitting membrane having emissivity equal to 0.1 and comprising square holes.

FIG. 14 shows an example of an IR emitter device 1 according to the invention, wherein the IR emitting membrane 10 comprises a plurality of resistive arms 4 connected to the IR emitting membrane 10, wherein the IR emitting membrane 10 is suspended by the resistive arms, wherein the IR emitting membrane 10 is heated to an IR emission temperature via those resistive arms 4. Each of the arms 4 in the illustrated example of FIG. 14 has a length 5, a width 6 and a thickness 7, and a cross-sectional area which is much smaller than that of the membrane 10. The connection pads 3 are designed to provide mechanical connection to a substrate such that the membrane 10 is only supported relative to the substrate by the arms 4 and pads 3. The connection pads 3 provide electrical connection to the arms 4, and thereby to the membrane 10. The membrane 10, pads 3 and arms 4 are preferably made of a single contiguous piece of material. Other features and other embodiments of this IR emitter device 1 and/or of this emitting membrane 10 are described in the documents WO2020012042, WO2021144463 or WO2021144464 filed by the applicant and enclosed here by reference.

Reference signs used in the FIGS.

| | |
|---|---|
| 1 | IR emitter device |
| 3 | Connection pad |
| 4 | Arm |
| 5 | Length of the arm |
| 6 | Width of the arm |
| 7 | Thickness of the arm |
| 10 | IR emitting membrane |
| 11 | First surface |
| 12 | Second surface |
| 20 | Cold mirror |
| 20′ | Hot mirror |
| 21 | Surface of the mirror |
| 40 | Hole |
| 44 | (Side)wall of the hole |
| 100 | First IR emitter device |
| 200 | Cold mirror |
| 200′ | Hot mirror |
| 300 | Optics |
| 400 | Second IR emitter device |
| 1000 | IR emitter system |
| d | Distance between holes |
| D | Distance between the surface of the mirror facing a surface of |
| | the IR emitting membrane and that surface of the IR emitting |
| | membrane |
| P₁, . . . Pⱼ | Powers |
| t | Thickness |
| Ω₁, Ω₂ | Solid angles |

1. An IR emitter device for a predefined region of the electromagnetic spectrum, comprising:
an IR emitting membrane comprising a first surface and a second surface, the second surface being opposite to the first surface, wherein the IR emitting membrane is arranged to be heated to an IR emission temperature so that the first and second surfaces radiate IR light belonging to said region at the IR emission temperature; and
a mirror facing one of the first or second surfaces of the IR emitting membrane,
wherein at least a portion of the IR emitting membrane comprises through holes,
wherein an emissivity of the first and second surfaces is lower than 0.7,
wherein any cross section in a plane parallel to one of the first or second surfaces of the IR emitting membrane of said holes has a maximum dimension larger than the longest wavelength of said predefined region,
the sum of the areas of the holes being at least 10% of the area of each of the first or second surfaces of the IR emitting membrane, in order to improve the emissivity of the IR emitter device.

2. The IR emitter device of claim 1, wherein the IR emitting membrane is made by or comprises a refractory material.

3. The IR emitter device of claim 1, wherein the surface of the mirror facing the IR emitting membrane is an IR emitting surface.

4. The IR emitter device of claim 3, wherein the surface of the mirror facing the IR emitting membrane, the first surface, and the second surface of the IR emitting membrane are made by the same material.

5. The IR emitter device of claim 3, wherein the IR emitting device is a monobloc device.

6. The IR emitter device of claim 1,
wherein the surface of the mirror facing the IR emitting membrane is not an IR emitting surface, and
wherein the reflectivity of the mirror is higher than 80%.

7. The IR emitter device of claim 1, wherein the thickness of the IR emitting membrane is higher than 0.1 times the mean distance between the holes.

8. The IR emitter device of claim 7, wherein the ratio of the area of the hole and the area of the sidewalls of the hole is lower than 1.

9. The IR emitter device of claim 1,
wherein the thickness of the IR emitting membrane is equal or lower than 0.1 times the mean distance between the holes, and
wherein the sum of the areas of the holes is less than 50% of the area of each of the first or second surfaces of the IR emitting membrane.

10. The IR emitter device of claim 1,
wherein the mirror is planar, and
wherein the distance of the mirror from the membrane is a multiple of the average distance between two adjacent holes or a multiple of the holes period.

11. The IR emitter device of claim 1, wherein at least some of the holes are squared holes or cross holes.

12. The IR emitter device of claim 1, wherein the arrangement of the holes is not periodic and/or wherein the holes have different sizes and/or different shapes.

13. The IR emitter device of claim 1, comprising a plurality of resistive arms connected to the IR emitting membrane,
wherein the IR emitting membrane is suspended by the resistive arms, and
wherein the IR emitting membrane is heated to an IR emission temperature via said resistive arms.

14. The IR emitter device of claim 1, said predefined region ranging from 0.9 μm to 3 μm.

15. The IR emitter device of claim 1, wherein the first or second surface of the IR emitting membrane facing the mirror and a surface of the mirror are in direct contact.
